(19) United States
(12) Patent Application Publication
(10) Pub. No.: US 2008/0225789 A1
(43) Pub. Date: Sep. 18, 2008

(54) System and method for allocating resources in a communication system

(75) Inventors: Do-Young Kim, Yongin-si (KR); Dong-Seek Park, Yongin-si (KR); Ho-Kyu Choi, Seongnam-si (KR); Sung-Kwon Hong, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/075,874

(22) Filed: Mar. 14, 2008

(30) Foreign Application Priority Data
Mar. 14, 2007 (KR) 2007-24923

(51) Int. Cl. H04Q 7/00

(52) U.S. Cl. 370/329

(57) ABSTRACT

A method and system for allocating resources in a communication system including a first system having a use right for a plurality of frequency bands, and a second system having no use right for the plurality of frequency bands. The method includes acquiring first, second and third sensing informations indicating frequency bands available by a base station, a relay station and a mobile station belonging to the second system, among the plurality of frequency bands; and selecting a frequency band to be allocated for communications, based on the acquired sensing informations.

### CROSS-REFERENCE TO RELATED APPLICATION(S) AND CLAIM OF PRIORITY

The present application claims the benefit under 35 U.S.C. §119(a) of a Korean Patent Application filed in the Korean Intellectual Property Office on Mar. 14, 2007 and assigned Serial No. 2007-24923, the disclosure of which is incorporated herein by reference.

### TECHNICAL FIELD OF THE INVENTION

The present invention relates generally to a communication system, and in particular, to a communication system for selecting a frequency band and allocating resources in a cognitive radio (CR) communication system, and a method for supporting the same.

### BACKGROUND OF THE INVENTION

In the next generation communication systems, intensive research is being conducted to provide users with services based on various Qualities of Service (QoS).

The next generation communication system should efficiently use limited resources, since a plurality of cells constituting the communication system use the limited resources (e.g., frequency resource, code resource, time slot resource, etc.) on a shared basis. Particularly, with the rapid progress of the radio communication systems and the advent of various services, there is an increasing need for radio resources. However, since almost all commercially available frequency bands have now been allocated, there is a significant lack of frequency resources for new radio platforms.

To solve such frequency lacking problems, a cognitive radio (CR) communication system based on a CR scheme has been proposed. The CR communication system senses frequency bands which have been allocated but are not in actual use, and efficiently shares the sensed frequency bands. A typical example of the CR communication system includes an IEEE 802.22 Wireless Regional Area Networks (WRAN) system, and the IEEE 802.22 WRAN system introduces the CR technology in the TV frequency band to use an unused TV band(s) for data transmission/reception.

However, in the CR communication system, if a primary system, while a secondary system secures and uses frequency resources, intends to use the frequency band secured and used by the secondary system, the secondary system should immediately stop the use of the frequency band. The ‘primary system’ as used herein means a communication system having a legal right to use the frequency band.

Meanwhile, in order to sense a frequency band which has been allocated to the primary system but is not used actually, the secondary system measures strength of a received signal in the frequency band. Thereafter, the secondary system uses the frequency band, sensing the nonuse of the frequency band by the primary system depending on the measure strength of the received signal. If the strength of the received signal is greater than or equal to a predetermined threshold, the secondary system determines that the desired frequency band is used by another system.

However, the signal received at the secondary system may include not only the transmission and reception signals of the primary system, but also the interference signal (e.g., a transmission or reception signal of another secondary system). It is difficult for the secondary system to determine whether the received signal is a signal of the primary system or an interference signal. In order to detect the signal of the primary system in the frequency band, the secondary system performs correlation calculation using a periodic characteristic of the signal of the primary system, causing an increase in the system complexity. In addition, when the secondary system uses a cyclo-stationary characteristic to detect the primary system signal or the interference signal in the frequency band, it may suffer from latency, causing an increase in the time required for sensing the frequency band.

Further, in the CR communication system, when the secondary system uses a multi-hop relay scheme based on a relay station (RS), it is not possible to apply the multi-hop relay scheme to the CR communication system since there is no way to allocate frequency band resources.

### SUMMARY OF THE INVENTION

To address the above-discussed deficiencies of the prior art, it is a primary aspect of the present invention to address at least the problems and/or disadvantages and to provide at least the advantages described below. Accordingly, an aspect of the present invention provides a resource allocation system for improving data transmission and reception efficiency in a cognitive radio (CR) communication system, and a method for supporting the same.

Another aspect of the present invention provides a system for allocating resources in a CR communication system to which a multi-hop relay scheme is applied, and a method for supporting the same.

According to one aspect of the present invention, there is provided a system for allocating resources in a communication system including a first system having a use right for a plurality of frequency bands, and a second system having no use right for the plurality of frequency bands. The system includes a station for acquiring first, second and third sensing informations indicating frequency bands available by a base station, a relay station and a mobile station belonging to the second system, among the plurality of frequency bands, and selecting a frequency band to be allocated for communications, based on the acquired sensing informations.

According to another aspect of the present invention, there is provided a method for allocating resources in a communication system including a first system having a use right for a plurality of frequency bands, and a second system having no use right for the plurality of frequency bands. The method includes acquiring first, second and third sensing informations indicating frequency bands available by a base station, a relay station and a mobile station belonging to the second system, among the plurality of frequency bands; and selecting a frequency band to be allocated for communications, based on the acquired sensing informations.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “station” means any device, system or part thereof that controls at least one operation, such a device may be implemented in hardware, firmware or software, or some combination of at least two of the same. It should be noted that the functionality associated with any particular station may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a configuration of a CR communication system according to an embodiment of the present invention;

FIG. 2 is a diagram illustrating a frame structure of a secondary system used in a CR communication system according to an embodiment of the present invention; and

FIG. 3 is a diagram illustration an operation of a secondary system in a CR communication system according to an embodiment of the present invention.

### DETAILED DESCRIPTION OF THE INVENTION

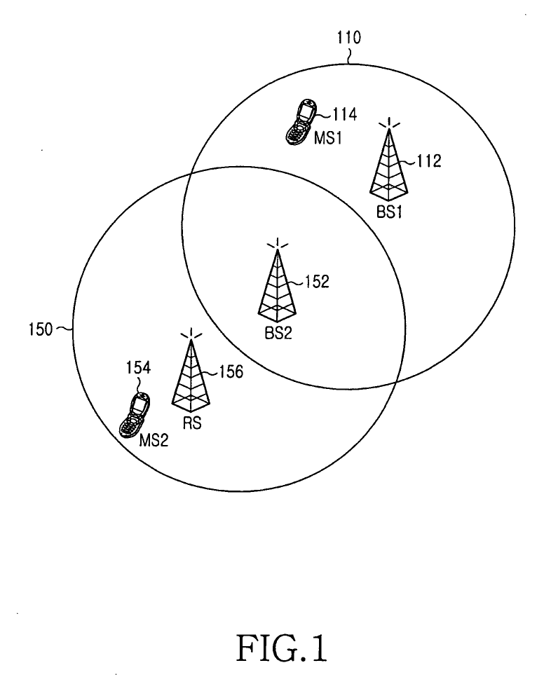

FIGS. 1 through 3, discussed below, and the various embodiments used to describe the principles of the present disclosure in this patent document are by way of illustration only and should not be construed in any way to limit the scope of the disclosure.

Those skilled in the art will understand that the principles of the present disclosure may be implemented in any suitably arranged wireless communication system.

An embodiment of the present invention, described below, provides a communication system and method in which when a primary system having a right to use a specific frequency band does not use the frequency band, a secondary system is allowed to use the frequency band. In the following description, the communication system allowing the secondary system to use the frequency band unused by the primary system will be referred to as a cognitive radio (CR) communication system.

In addition, an embodiment of the present invention, described below, provides a resource allocation system and method for a CR communication system to which a multi-hop relay scheme is applied.

Although a description of the present invention will be given herein for a resource allocation system and method for a CR communication system as an example of the communication system using the Institute of Electrical and Electronics Engineers (IEEE) 802.22 standard, the resource allocation system and method proposed by the present invention can be applied not only to the CR communication system but also to all other communication systems.

FIG. 1 is a diagram illustrating a configuration of a CR communication system according to an embodiment of the present invention.

Before a description of FIG. 1 is given, it will be assumed that the CR communication system includes a primary system and a secondary system, a cell 110 is managed by the primary system and a cell 150 is managed by the secondary system.

Referring to FIG. 1, the cell 110 includes a BS1 112 (or primary base station (BS)) and an MS1 114 (or primary mobile station (MS)) for receiving a communication service from the BS1 112, and the cell 150 includes a BS2 152 (or a secondary BS), an MS2 154 (or a secondary MS) for receiving a communication service from the BS2 152, and a relay station (RS) 156 for providing multi-hop between the BS2 152 and the MS2 154.

The BS1 112, while providing a communication service to the MS1 114 over a specific frequency band, receives the current location information and Channel State Information (CSI) of the MS1 114, being fed back from the MS1 114.

At this point, the BS2 152 senses spectrums in a frequency band whose right-to-use (hereinafter ‘use right’) belongs to the primary system, thereby to sense (search for) a frequency band unused by the primary system. Further, the BS2 152 generates sensing information indicating the sensed frequency band. The MS2 154 measures interference information based on its own communication environment, for example, noise and interference situation, and senses spectrums in a frequency band unoccupied in the position where it is now located (i.e., in the frequency band whose use right belongs to the primary system), thereby to sense a frequency band unused by the BS1 112 and the MS1 114 of the primary system. Further, the MS2 154 generates sensing information indicating the sensed frequency band. In addition, the RS 156 senses spectrums in a frequency band whose use right belongs to both the BS2 152 and the primary system, thereby to sense a frequency band unused by the primary system. Further, the RS 156 generates sensing information indicating the sensed frequency band.

In this way, the BS2 152, MS2 154 and RS 156 each sense a frequency band unused by the primary system, and generate sensing information indicating the sensed frequency band. Thereafter, they transmit the generated sensing information in a message. Also, each entity receives sensing information indicating a frequency band sensed by other elements of the secondary system except for the entity itself.

That is, the BS2 152 broadcasts its generated sensing information to the MS2 154 and the RS 156 along with a broadcast message (e.g., MAP-message) and the MS2 154 includes its generated sensing information in feedback information, and then transmits a control message with the feedback information included therein to the RS 156 and the BS2 152. Also, the RS 156 broadcasts its generated sensing information to the MS2 154 along with a MAP-message, includes the generated sensing information in feedback information, and then transmits a control message with the feedback information included therein to the BS2 152.

As a result, the sensing information transmitted by the BS2 152 indicates information on an available frequency band of the secondary system, which has been sensed by sensing spectrums in a frequency band whose use right belongs to the primary system. The BS2 152 receives sensing information for an available frequency band of the secondary system from the RS 156 and the MS2 154. The MS2 154 transmits, to the BS2 152 and the RS 156, sensing information indicating available frequency band information of the secondary system, sensed by sensing spectrums in a frequency band whose use right belongs to the primary system, and receives sensing information for an available frequency band of the secondary system from the BS2 152 and the RS 156. In addition, the RS 156 transmits, to the BS2 152 and the MS2 154, sensing information indicating available frequency band information of the secondary system, sensed by sensing spectrums in a frequency band whose use right belongs to the primary system, and receives sensing information for an available frequency band of the secondary system from the BS2 152 and the MS2 154.

Therefore, upon receiving available frequency band information of the secondary system, sensed by sensing spectrums in the frequency band whose use right belongs to the primary system from other elements of the secondary system except for the corresponding entity itself, each of the BS2 152, MS2 154 and RS 156 compares an available frequency band of the secondary system, sensed by the corresponding entity itself, with an available frequency band of the secondary system, sensed by other elements of the secondary system, and selects the optimal frequency band available in the secondary system, i.e., the optimal frequency band available by the BS2 152, MS2 154 and RS 156 depending on the comparison result.

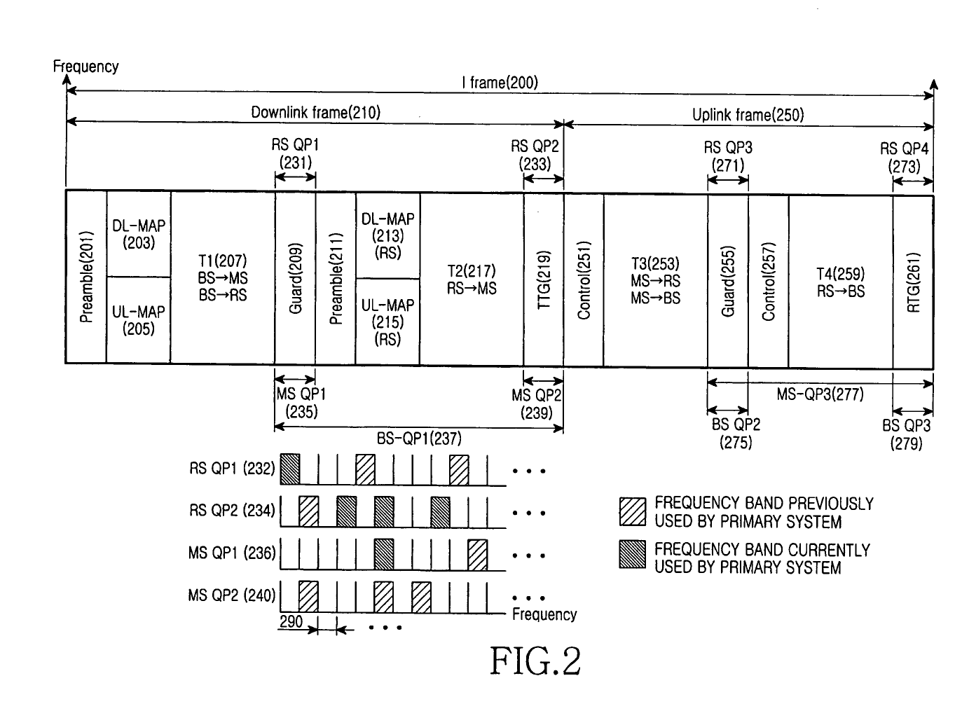

FIG. 2 is a diagram illustrating a frame structure of a secondary system used in a CR communication system according to an embodiment of the present invention. Herein, shown in FIG. 2 is a frame structure of a secondary system in a CR communication system according to an embodiment of the present invention.

Referring to FIG. 2, the frame 200 includes a downlink (DL) frame 210 and an uplink (UL) frame 250. The DL frame 210 includes a region 207 where a BS of a secondary system transmits a signal to an RS and an MS of the secondary system, located in its own cell, and a region 217 where the RS of the secondary system transmits a signal to an MS of the secondary system, to which a relay path to the BS of the secondary system is formed via the RS itself. The UL frame 250 includes a region 253 where the MS of the secondary system transmits a signal to the BS of the secondary system, which provides a service to the MS itself, and to the RS of the primary system, to which a relay path to the MS itself is formed, and a region 259 where the RS of the secondary system transmits a signal to the BS of the secondary system.

More specifically, the DL frame 210 includes a preamble region 201 for transmitting a synchronization signal for synchronization acquisition of a transmission/reception interval of the secondary system (i.e., synchronization acquisition between the BS and the MS of the secondary system or between the BS and the RS of the secondary system); a DL-MAP region 203 and a UL-MAP region 205 for transmitting DL-MAP information and UL-MAP information, respectively; a first data transmission region (T1) 207 where the BS of the secondary system transmits data to the RS and the MS of the secondary system, located in its own cell; and a guard region 209 for separation between a BS transmission region and an RS transmission region of the secondary system.

In the CR communication system according to an embodiment of the present invention, the BS of the secondary system senses spectrums in the frequency band whose use right belongs to the primary system. Thereafter, the BS includes, in DL-MAP information, sensing information indicating information on an available frequency band of the secondary system, sensed by sensing the spectrums, and transmits the DL-MAP information to the RS and the MS of the secondary system over the DL-MAP region 203. In the UL, the BS includes, in UL-MAP information, sensing information indicating information on an available frequency band of the secondary system, and transmits the UL-MAP information to the RS and the MS of the secondary system over the UL-MAP region 205.

Further, the DL frame 210 includes a preamble region 211 for transmitting a synchronization signal for synchronization acquisition of a transmission/reception interval, i.e., for synchronization signal between the RS and the MS of the secondary system using a region over which the RS of the secondary system transmits a signal to an MS, like the preamble region 201; a DL-MAP region 213 and a UL-MAP region 215 for transmitting DL-MAP information and UL-MAP information, respectively; a second data transmission region (T2) 217 where the RS of the secondary system transmits data to the MS of the secondary system, to which a relay path to the RS itself is formed; and a Transmit Transition Gap (TTG) region 219 as a guard interval for separation between the DL frame 210 and the UL frame 250.

In the CR communication system according to an embodiment of the present invention, the RS of the secondary system senses spectrums in the frequency band whose use right belongs to the primary system. Thereafter, the RS includes, in DL-MAP information, sensing information indicating information on an available frequency band of the secondary system, sensed by sensing the spectrums, and transmits the DL-MAP information to the BS and the MS of the secondary system over the DL-MAP region 213. In the UL, the RS includes, in UL-MAP information, sensing information indicating information on available frequency band of the secondary system, and transmits the UL-MAP information to the BS and the MS of the secondary system over the UL-MAP region 215.

The UL frame 250 includes a control region 251 over which the MS of the secondary system transmits various control information as feedback information; a third data transmission region (T3) 253 over which the MS of the secondary system transmits data to the BS and the RS of the secondary system, which provides a service to the MS itself; and a guard region 255 for separation between the MS transmission region and the RS transmission region of the secondary system.

In the CR communication system according to an embodiment of the present invention, the MS of the secondary system senses spectrums in the frequency band whose use right belongs to the primary system. Thereafter, the MS includes, in control information, sensing information indicating available frequency band information of the secondary system, sensed by sensing the spectrums, and transmits the control information to the BS and the RS of the secondary system over the control region 251.

Further, the UL frame 250 includes a control region 257 over which the RS of the secondary system transmits various control information as feedback information; a fourth data transmission region (T4) 259 over which the RS of the secondary system transmits data to the BS of the secondary system, to which a relay path to the RS itself is formed; and a Receive Transition Gap (RTG) region 261 as a guard interval between the UL frame 250 of the current frame and a DL frame of the next frame of the secondary system.

In the CR communication system according to an embodiment of the present invention, the RS of the secondary system senses spectrums in the frequency band whose use right belongs to the primary system. Thereafter, the RS transmits sensing information indicating available frequency band information of the secondary system, sensed by sensing the spectral region, to the BS of the secondary system over the control region 257.

At this point, each of the BS, RS and MS of the secondary system generates sensing information indicating an available frequency band of the secondary system for a period defined by a signal transmission/reception region of the frame, which is irrelevant to the corresponding entity itself. More specifically, the BS of the secondary system senses a frequency band available by the secondary system by sensing spectrums in the frequency band whose use right belongs to the primary system, for periods defined by signal transmission/reception regions irrelevant to the BS itself in the frame, i.e., for a first Quiet Period (QP) 237 of the BS (hereinafter ‘BS QP1’) in the DL frame 210, and a second QP 275 of the BS (hereinafter ‘BS QP2’) and a third QP 279 of the BS (hereinafter ‘BS QP3’) in the UL frame 250. Thereafter, the BS of the secondary system generates sensing information indicating a frequency band available by the secondary system.

The BS QP1 237 includes the guard region 209, preamble region 211, DL-MAP region 213, UL-MAP region 215, T2 217 and TTG region 219 of the DL frame 210, the BS QP2 275 includes the guard region 255 of the UL frame 250, and the BS QP3 279 includes the RTG region 261 of the UL frame 250.

The RS of the secondary system senses a frequency band available by the secondary system by sensing spectrums in the frequency band whose use right belongs to the primary system, for periods defined by signal transmission/reception regions irrelevant to the RS itself in the frame, i.e., for a first QP 231 of the RS (hereinafter ‘RS QP1’) and a second QP 233 of the RS (hereinafter ‘RS QP2’) in the DL frame 210; and a third QP 271 of the RS (hereinafter ‘RS QP3’) and a fourth QP 273 of the RS (hereinafter ‘RS QP4’) in the UL frame 250. Thereafter, the RS of the secondary system generates sensing information indicating a frequency band available by the secondary system.

The RS QP1 231 includes the guard region 209 of the DL frame 210; the RS QP2 233 includes the TTG region 219 of the DL frame 210; the RS QP3 271 includes the guard region 255 of the UL frame 250; and the RS QP4 273 includes the RTG region 261 of the UL frame 250.

The MS of the secondary system senses a frequency band available by the secondary system by sensing spectrums in the frequency band whose use right belongs to the primary system, for periods defined by signal transmission/reception regions irrelevant to the MS itself in the frame, i.e., for a first QP 235 of the MS (hereinafter ‘MS QP1’) and a second QP 239 of the MS (hereinafter ‘MS QP2’) in the DL frame 210, and a third QP 277 of the MS (hereinafter ‘MS QP3’) in the UL frame 250. Thereafter, the MS of the secondary system generates sensing information indicating a frequency band available by the secondary system.

The MS QP1 235 includes the guard region 209 of the DL frame 210; the MS QP2 239 includes the TTG region 219 of the DL frame 210; and the MS QP3 277 includes the guard region 255, control region 257, T4 259 and RTG region 261 of the UL frame 250.

In this way, each of the BS, RS and MS of the secondary system senses a frequency band available by the secondary system by sensing spectrums in the frequency band corresponding to the corresponding entity itself in the frame 200. Thereafter, the RS and the MS each generate its sensed sensing information and transmit the sensing information to the BS over the corresponding region of the frame 200. Here, the sensing information indicates a frequency band(s) available by the secondary system, sensed by each of the BS, RS and MS.

Upon receiving the sensing information from the RS and the MS, the BS compares a resource occupation rate in each frequency band based on the received sensing information and its generated sensing information. Based on the comparison result, the BS preferentially allocates a frequency band with a lower resource occupation rate to the MS.

That is, the BS determines, as the lowest level, a resource occupation rate of a first frequency band unused by any station among all frequency bands. The BS determines a resource occupation rate of a second frequency band previously used by the primary system, as a low level corresponding to a level higher than the lowest level. The BS determines a third frequency band currently used by the primary system as the highest level corresponding to a level higher than the low level.

Therefore, the BS can allocate the first frequency band, the second frequency band and the third frequency band to the MS in order, and for this, transmits a Downlink Stream (DS)-MAP including information indicating the allocated frequency band, to the MS directly or via the RS. If there are frequency bands having the same resource occupation rate as a result of the comparison, the BS selects the RS, which is its nearest station, and selects one of the frequency bands according to the sensing information of the selected RS.

For example, reference numerals 232 and 234 shown in FIG. 2 represent sensing information generated by the RS in the RS QP1 231 and RS QP2 233, respectively, and reference numerals 236 and 240 represent sensing information generated in the MS QP1 235 and MS QP2 239, respectively. A shown frequency band 290 has a resource occupation rate corresponding to the lowest level. Therefore, the BS transmits a DS-MAP message with information on the frequency band 290 to the MS via the RS, thereby allocating to the MS the frequency band 290 which is one of the frequency bands having the lowest-level resource occupation rate.

With reference to FIG. 2, a description has been made an exemplary method in which the BS preferentially allocates a frequency band with the lowest resource occupation rate to the MS based on its generated sensing information and the sensing information received from the RS and the MS. Alternatively, however, the MS can select a frequency band with the lowest resource occupation rate based on its generated sensing information and the sensing information received from the BS and the RS, and send a request for allocation of the selected frequency band to the BS.

A DS-MAP message format the BS transmits to the MS for allocation of a frequency band can be defined as Table 1.

TABLE 1

| Syntax | Size | Notes |
|---|---|---|
| RS DS-MAP_Message_Format( ) { | | |
| Management Message Type =1 | 8 bits | |
| Synchronization Field | 16 bits | |
| RS ID | 48 bits | |
| Begin PHY Specific Section { | | |
| for (i=1; i≦n; i++) { | | |
| RS DS-MAP_IE( ) | Variable | |
| } | | |
| RS+BS sensing information | n bits | |
| Entity selection request | n bits | |

In Table 1, an ‘RS+BS sensing information’ field includes sensing information of the RS and the BS, and an ‘Entity selection request’ field indicates frequency band information selected by the BS. Herein, the ‘RS+BS sensing information’ field can be provided only when the BS needs it.

A Bulk Measurement Report (BLM-REP) message format the MS transmits for allocation request of a frequency band can be defined as Table 2.

TABLE 2

| Syntax | Size | Notes |
|---|---|---|
| BLM-REP_Message_Format( ) { | | |
| Management Message Type = 41 | 8 bits | |
| Transaction ID | 16 bits | |
| Number of Single Measurement | 8 bits | The number of single |
| Reports | | measurement reports |
| | | contained in this |
| | | message. |
| sensing information | Variable | |
| Entity selection response | n bits | |

In Table 2, a ‘sensing information’ field includes sensing information the RS, the BS and the MS, and an ‘Entity selection response’ field indicates frequency band information selected by the MS. Herein, the ‘sensing information’ field can be provided only when the MS needs it.

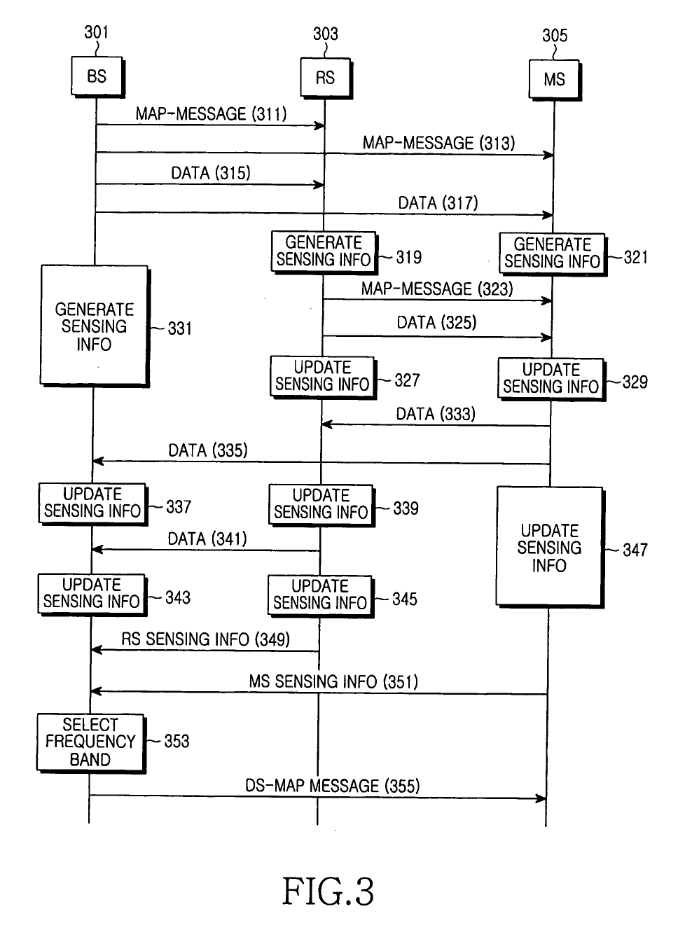

FIG. 3 is a diagram illustration an operation of a secondary system in a CR communication system according to an embodiment of the present invention. Shown in FIG. 3 is a signal transmission/reception flow between a BS, an RS and an MS of a secondary system in a CR communication system according to an embodiment of the present invention.

Referring to FIG. 3, a BS 301 of the secondary system transmits a MAP-message to an RS 303 and an MS 305 of the secondary system over a DL-MAP region 203 of a frame 200 (Steps 311 and 313). The MAP-message is transmitted to the RS 303 and the MS 305 of the secondary system in a broadcast message form. Thereafter, the BS 301 of the secondary system transmits data to the RS 303 and the MS 305 of the secondary system over a T1 207 of the frame 200 (Steps 315 and 317).

Upon receiving data from the BS 301 of the secondary system in this way, the RS 303 and the MS 305 of the secondary system search the frame 200 for a frequency band available by the secondary system during a guard region 209 of a DL frame 210. That is, the RS 303 of the secondary system senses (searches for) a frequency band available by the secondary system by sensing spectrums in a frequency band whose use right belongs to the primary system during an RS QP1 231, and generates the sensing information (Step 319). The MS 305 of the secondary system senses a frequency band available by the secondary system by sensing spectrums in a frequency band whose use right belongs to the primary system during an MS QP1 235, and generates the sensing information (Step 321).

Thereafter, the RS 303 of the secondary system transmits a MAP-message to the MS 305 of the secondary system over a DL-MAP region 213 of the frame 200 (Step 323), and then transmits data to the MS 305 of the secondary system over a T2 217 of the frame 200 (Step 325). Next, the RS 303 and the MS 305 of the secondary system sense a frequency band(s) available by the secondary system during a TTG region 219 of the DL frame 210 in the frame 200. That is, the RS 303 of the secondary system senses a frequency band available by the secondary system by sensing spectrums in a frequency band whose use right belongs to the primary system during an RS QP2 233, and updates the sensing information (Step 327). The MS 305 of the secondary system senses a frequency band available by the secondary system by sensing spectrums in a frequency band whose use right belongs to the primary system during an MS QP2 239, and updates the sensing information (Step 329).

The BS 301 of the secondary system senses a frequency band available by the secondary system during a guard region 209, a preamble region 211, a DL-MAP region 213, a UL-MAP region 215, a T2 217 and a TTG region 219 of the DL frame 210 in the frame 200. That is, the BS 301 of the secondary system senses a frequency band available by the secondary system by sensing spectrums in a frequency band whose use right belongs to the primary system during a BS QP1 237 (Step 331). Thereafter, the MS 305 of the secondary system transmits control information and data to the BS 301 and the RS 303 of the secondary system over a control region 251 and a T3 253 of the frame 200 (Steps 333 and 335).

Thereafter, the BS 301 and the RS 303 of the secondary system sense a frequency band available by the secondary system during a guard region 255 of a UL frame 250 in the frame 200. That is, the BS 301 of the secondary system senses a frequency band available by the secondary system by sensing spectrums in a frequency band whose use right belongs to the primary system during a BS QP2 275, and updates the sensing information (Step 337). The RS 303 of the secondary system senses a frequency band available by the secondary system by sensing spectrums in a frequency band whose use right belongs to the primary system during an RS QP3 271, and updates the sensing information (Step 339).

Thereafter, the RS 303 of the secondary system transmits control information and data to the BS 301 of the secondary system over a control region 257 and a T4 259 of the frame 200 (Step 341). Then the BS 301 and the RS 303 of the secondary system sense a frequency band available by the secondary system during an RTG region 261 of the UL frame 250 in the frame 200. That is, the BS 301 of the secondary system senses a frequency band available by the secondary system by sensing spectrums in a frequency band whose use right belongs to the primary system during a BS QP3 279, and updates the sensing information (Step 343). The RS 303 of the secondary system senses a frequency band available by the secondary system by sensing spectrums in a frequency band whose use right belongs to the primary system during an RS QP4 273, and updates the sensing information (Step 345).

The MS 305 of the secondary system senses a frequency band available by the secondary system during a guard region 255, a control region 257, a T4 259 and an RTG region 261 of the UL frame 250 in the frame 200. That is, the MS 305 senses a frequency band available by the secondary system by sensing spectrums in a frequency band whose use right belongs to the primary system during an MS QP3 277, and updates the sensing information (Step 347).

The BS 301 receives the RS sensing information generated in steps 319, 327, 339 and 345, and the MS sensing information generated in steps 321, 329 and 347 (Steps 349 and 351). Therefore, the BS compares a resource occupation rate in each frequency band based on the received RS sensing information and MS sensing information, and its sensing information generated in steps 331, 337 and 343. Thereafter, the BS 301 selects a frequency band having the lowest resource occupation rate (Step 353). The BS 301 transmits a DS-MAP message with the selected frequency band information to the MS 305 (Step 355).

A description has been made of a method in which the BS selects the frequency band with the lowest resource occupation rate based on its generated sensing information and the sensing information received from the RS and the MS, and allocates the selected frequency band to the MS. However, in an alternative embodiment, the MS can select a frequency band with the lowest resource occupation rate based on its generated sensing information and the sensing information received from the BS and the RS, and can be allocated a corresponding frequency band by sending a request for allocation of the selected frequency band. In this case, steps 349 to 355 are deleted, and the following process should be added.

That is, the MS 305 receives the RS sensing information and the BS sensing information, compares a resource occupation rate in each frequency band based on the received RS sensing information and BS sensing information, and its generated sensing information, selects a frequency band with the lowest resource occupation rate, and transmits a BLM-REP message with the selected frequency band information to the BS 301.

As is apparent from the foregoing description, in the CR communication system according to the present invention, the BS, the RS and the MS of the secondary system each sense an available frequency band and share the sensing information, making it possible to allocate the optimal frequency band available by the secondary system. In addition, the present invention transmits/receives data using the optimal frequency band in the CR communication system to which the multi-hop relay scheme is applied, thereby contributing to an increase in the data transmission/reception efficiency.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for allocating resources in a communication system including a first system having a use right for a plurality of frequency bands, and a second system having no use right for the plurality of frequency bands, the method comprising:
acquiring first, second and third sensing informations indicating frequency bands available by a base station, a relay station and a mobile station belonging to the second system, among the plurality of frequency bands; and
selecting a frequency band to be allocated for communications, based on the acquired sensing informations.

2. The method of claim 1, further comprising:
transmitting by the base station a resource allocation message indicating the selected frequency band to the mobile station.

3. The method of claim 1, further comprising:
transmitting, by the mobile station, a resource allocation request message requiring the selected frequency band to the base station.

4. The method of claim 1, wherein the selecting comprises:
comparing a resource occupation rate of each of the plurality of frequency bands based on the sensing informations; and
selecting one frequency band having a relatively low resource occupation rate.

5. The method of claim 1, wherein the selecting comprises:
selecting the frequency band to be allocated, in order of a frequency band unused in the first system, a frequency band previously used in the first system, and a frequency band currently used in the first system.

6. The method of claim 4, wherein the selecting comprises:
selecting the frequency band according to the second sensing information when there are frequency bands having the same resource occupation rate as a result of the comparison.

7. The method of claim 1, wherein the first sensing information is generated by sensing, by the base station, spectrums of the plurality of frequency bands during a signal transmission-reception region irrelevant to the base station.

8. The method of claim 7, wherein the signal transmission-reception region irrelevant to the base station includes at least one of guard regions in a frame and a signal transmission-reception region between the mobile station and the relay station.

9. The method of claim 1, wherein the second sensing information is generated by sensing, by the relay station, spectrums of the plurality of frequency bands during a signal transmission-reception region irrelevant to the relay station.

10. The method of claim 9, wherein the signal transmission-reception region irrelevant to the relay station includes at least one of guard regions in a frame.

11. The method of claim 1, wherein the third sensing information is generated by sensing, by the mobile station, spectrums of the plurality of frequency bands during a signal transmission-reception region irrelevant to the mobile station.

12. The method of claim 11, wherein the signal transmission-reception region irrelevant to the mobile station includes at least one of guard regions in a frame.

13. A system for allocating resources in a communication system including a first system having a use right for a plurality of frequency bands, and a second system having no use right for the plurality of frequency bands, the system comprising:
a station for acquiring first, second and third sensing informations indicating frequency bands available by a base station, a relay station and a mobile station belonging to the second system, among the plurality of frequency bands, and selecting a frequency band to be allocated for communications, based on the acquired sensing informations.

14. The system of claim 13, wherein the station denotes the base station, and the base station transmits a resource allocation message indicating the selected frequency band to the mobile station.

15. The system of claim 13, wherein the station denotes the mobile station, and the mobile station transmits a resource allocation request message requiring the selected frequency band to the base station.

16. The system of claim 13, wherein the station compares a resource occupation rate of each of the plurality of frequency bands based on the sensing informations, and selects one frequency band having a relatively low resource occupation rate.

17. The system of claim 13, wherein the station selects the frequency band to be allocated, in order of a frequency band unused in the first system, a frequency band previously used in the first system, and a frequency band currently used in the first system.

18. The system of claim 16, wherein the station selects the frequency band according to the second sensing information when there are frequency bands having the same resource occupation rate as a result of the comparison.

19. The system of claim 13, wherein the first sensing information is generated by sensing, by the base station, spectrums of the plurality of frequency bands during a signal transmission-reception region irrelevant to the base station.

20. The system of claim 19, wherein the signal transmission-reception region irrelevant to the base station includes at least one of guard regions in a frame and a signal transmission-reception region between the mobile station and the relay station.

21. The system of claim 13, wherein the second sensing information is generated by sensing, by the relay station, spectrums of the plurality of frequency bands during a signal transmission-reception region irrelevant to the relay station.

22. The system of claim 21, wherein the signal transmission-reception region irrelevant to the relay station includes at least one of guard regions in a frame.

23. The system of claim 13, wherein the third sensing information is generated by sensing, by the mobile station, spectrums of the plurality of frequency bands during a signal transmission-reception region irrelevant to the mobile station.

24. The system of claim 23, wherein the signal transmission-reception region irrelevant to the mobile station includes at least one of guard regions in a frame.
